(19) United States
(12) Patent Application Publication
(10) Pub. No.: US 2015/0000631 A1
(43) Pub. Date: Jan. 1, 2015

(54) FUEL QUALITY DEPENDENT INJECTION CONTROL APPARATUS AND METHOD THEREOF

(71) Applicant: Hyundai Motor Company, Seoul (KR)

(72) Inventor: Chang Yeol Choi, Suwon-si (KR)

(73) Assignee: Hyundai Motor Company, Seoul (KR)

(21) Appl. No.: 14/144,477

(22) Filed: Dec. 30, 2013

(30) Foreign Application Priority Data
Jun. 28, 2013 (KR) 10-2013-0075367

(51) Int. Cl. F02D 41/30

(52) U.S. Cl. CPC F02D 41/30
USPC 123/305

(57) ABSTRACT

A fuel injection control apparatus and method of a diesel vehicle provides optimized combustion performance by controlling injection timing according to a cetane number deviation of diesel fuel. The method includes: detecting driving information to determine whether a cetane number measure mode is satisfied; detecting a combustion pressure by injecting a pilot fuel amount when the cetane number measuring mode is satisfied; calculating a heat release rate from the combustion pressure; calculating start timing of combustion from the HHR, thereby calculating an ignition delay time from fuel injection timing to the start timing of combustion; calculating a difference of the ignition delay time by comparing the ignition delay time of injected fuel to a standard ignition delay time; and determining a cetane number of quality of fuel according to the difference of the ignition delay time.

### CROSS-REFERENCE TO RELATED APPLICATION

The present application claims priority of Korean Patent Application Number 10-2013-0075367 filed Jun. 28, 2013, the entire contents of which application is incorporated herein for all purposes by this reference.

### BACKGROUND OF INVENTION

1. Field of Invention

The present invention is related to a fuel injection control apparatus and method of a diesel vehicle. More particularly, the present invention relates to a fuel injection control apparatus and method of a diesel vehicle that provides optimized combustion performance by controlling ignition timing according to a cetane number deviation of diesel fuel.

2. Description of Related Art

In a diesel vehicle, the most important factor in controlling noise, vibration, and harshness (NVH) is controlling combustion timing of pilot injection.

If the combustion timing of pilot injection is inaccurate, exact ignition delay is not performed. Therefore, combustion control of main injection is unstable, and thereby NVH and emissions are deteriorated.

According to a continuous demand for improvement of fuel efficiency for a vehicle and stricter regulations of discharge gas, closed loop control is applied for operating an engine.

In order to perform the closed loop control, when combustion pressure of each cylinder after top dead center is detected, current status of combustion is determined. Injection amount and injection timing are controlled according to the status of combustion, and an optimized status of combustion is maintained.

Performance of a vehicle depends on quality of fuel being combusted, and performance of a direct injection type of diesel vehicle depends on a cetane number of quality parameters of fuel.

In diesel fuel, the cetane number determines ignition, and the cetane number is related to injection timing of fuel and ignition time. The ignition time of diesel fuel having a high cetane number is short compared to diesel fuel having a low cetane number.

In diesel vehicles, regulation and management of the cetane number determining ignition of fuel is not performed, and injection timing and ignition amount is controlled by only combustion pressure.

Therefore, optimized combustion according to quality of fuel is not possible, and emissions may be deteriorated and fuel consumption may be increased.

For example, the cetane number of diesel fuel in the USA ranges from 42 to 52, and the cetane number of diesel fuel in Korea ranges from 52 to 54.

Exemplars of the prior art are Japanese Patent Laid-Open Publication No. 2008-163913 (Jul. 17, 2008) and Japanese Patent Laid-Open Publication No. 2009-013889 (Jan. 22, 2009).

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for an injection control apparatus controlling depending on fuel quality and a method having advantages of controlling injection timing according to cetane number deviation of diesel fuel, and thereby optimized combustion performance is guaranteed in countries without restriction of cetane number.

Various aspects of the present invention provide for an injection control apparatus controlling depending on fuel quality that includes a driving information detection unit detecting driving information which is necessary to drive the vehicle, a control unit determining a fuel injection amount and injection timing according to the driving information provided from the driving information detection unit, and an injector injecting a fuel amount calculated by the control unit, wherein the control unit detects a combustion pressure of each cylinder by injecting a pilot fuel amount when closed loop control is started after warm-up of an engine is completed, obtains a difference between ignition timings according to cetane numbers of fuels by calculating a heat release rate (HHR) from the combustion pressure, and controls the fuel injection timing based on the difference between the ignition timings.

The driving information detection unit may include an engine speed detection unit detecting an engine speed from a phase change of a crankshaft or camshaft, a coolant temperature detection unit detecting a temperature of a coolant circulating in the engine, an accelerator pedal detection unit detecting a displacement of an accelerator pedal according to tip-in or tip-out of the accelerator pedal, a vehicle speed detection unit detecting a vehicle speed from a rotation speed of an output shaft of a transmission, and a combustion pressure detection unit detecting the combustion pressure of each cylinder through a combustion sensor installed to each cylinder of the engine.

The control unit may determine that a cetane number measuring mode of fuel is performed when the coolant temperature exceeds a predetermined reference temperature and a fuel-cut control is performed during coasting of the vehicle.

The control unit may calculate start timing of combustion from the HHR calculated by the combustion pressure, calculates an ignition delay time (t) from the injection timing to the start timing of the combustion, and obtains an ignition delay difference (t−t2) by comparing the ignition delay time (t) to a standard ignition delay time (t2).

The control unit may advance the injection timing when the cetane number of the injected fuel is less than a cetane number of standard fuel, and delays the injection timing when the cetane number of the injected fuel is higher than a cetane number of standard fuel.

Various aspects of the present invention provide for an injection control method controlling depending on fuel quality that includes detecting driving information including an engine speed, a coolant temperature, a displacement accelerator pedal, and a vehicle speed, and thereby determining whether a cetane number measure mode is satisfied, detecting a combustion pressure of each cylinder by injecting a pilot fuel amount when the cetane number measuring mode is satisfied, calculating an HHR (heat release rate) from the combustion pressure of each cylinder, calculating start timing of combustion from the HHR, thereby calculating an ignition delay time from fuel injection timing to the start timing of combustion, calculating a difference of the ignition delay time by comparing the ignition delay time of injected fuel to a standard ignition delay time, and determining a cetane number of quality of fuel according to the difference of the ignition delay time.

The cetane number measuring mode may be determined when the temperature of a coolant exceeds a predetermined reference temperature (A ° C.) and fuel-cut control is performed during a coasting of a vehicle.

Accordingly, optimized combustion may be performed irrespective of deviation of cetane number of fuel in driving a diesel vehicle, therefore emissions are stabilized, and output of the engine and fuel consumption are improved.

Also, according to various aspects of the present invention, it is possible to provide stability and reliability while driving the vehicle in countries without restriction of cetane number.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 schematically shows an exemplary injection control apparatus controlling depending on fuel quality of a diesel vehicle according to the present invention.

FIG. 2 shows a flowchart of an exemplary injection control method controlling depending on fuel quality of a diesel vehicle according to the present invention.

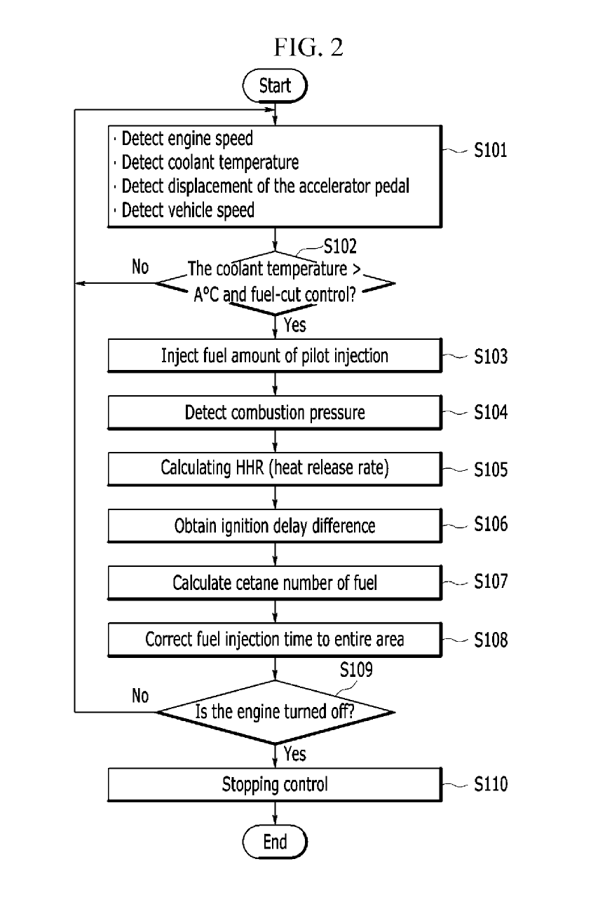

FIG. 3 shows an exemplary relationship between combustion pressure and HHR according to the present invention.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

The drawings and description are to be regarded as illustrative in nature, and not restrictive. Like reference numerals designate like elements throughout the specification.

In the drawings, the sizes and thicknesses of the components are merely shown for convenience of explanation, and therefore the present invention is not necessarily limited to the illustrations described and shown herein.

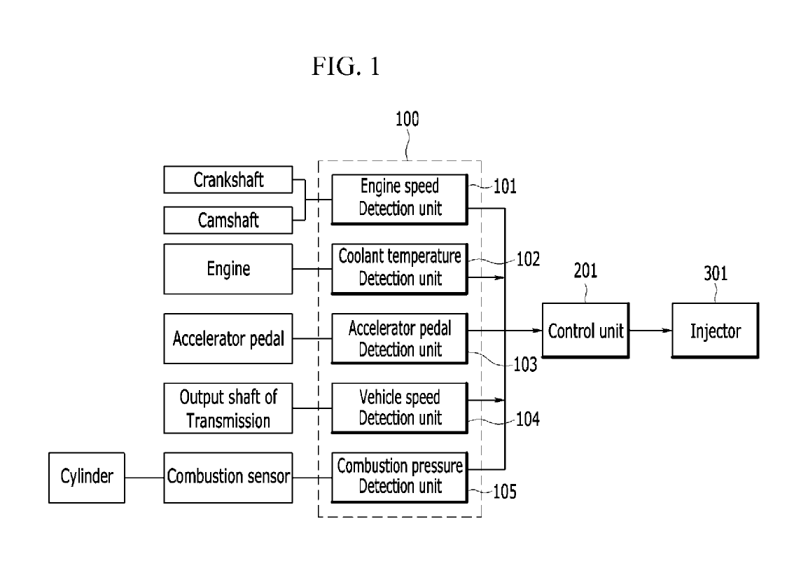

FIG. 1 schematically shows an injection control apparatus controlling depending on fuel quality of a diesel vehicle according to various embodiments of the present invention.

Referring to FIG. 1, various embodiments of the present invention includes a driving information detection unit, a control unit, and an injector.

The driving information detection unit detects overall driving information which is necessary to drive a diesel vehicle, including engine speed, coolant temperature, displacement of an accelerator pedal, vehicle speed, and combustion pressure, and provides the driving information to the control unit.

The driving information detection unit 100 includes an engine speed detection unit 101, a coolant temperature detection unit 102, an accelerator pedal detection unit 103, a vehicle speed detection unit 104, and a combustion pressure detection unit 105.

The engine speed detection unit 101 detects an engine speed from a phase change of a crankshaft or a camshaft, and provides an electrical signal of the engine speed to the control unit 201.

The coolant temperature detection unit 102 detects temperature of a coolant circulating in the engine, and provides an electrical signal of the coolant temperature to the control unit 201.

The accelerator pedal detection unit 103 detects displacement of the accelerator pedal according to tip-in or tip-out of an accelerator pedal, and provides an electrical signal of the displacement to the control unit 201.

The vehicle speed detection unit 104 detects vehicle speed from output shaft rotation speed of a transmission, and provides an electrical signal of the vehicle speed to the control unit 201.

The combustion pressure detection unit 105 is a combustion pressure sensor which is installed to each cylinder, detects combustion pressure of each cylinder, and provides an electrical signal of the combustion pressure to the control unit 201.

The control unit 201 determines a fuel injection amount and injection timing according to the driving information provided by the driving information detection unit 100, and controls combustion to be optimized.

The control unit 201 detects driving information including engine speed, coolant temperature, displacement of the accelerator pedal, vehicle speed, and combustion pressure, and determines whether closed loop control is performed after sufficient warm-up of the engine and the coolant temperature exceeds a predetermined reference temperature (A ° C.), and whether fuel-cut control is performed during coasting of the vehicle.

The reference temperature (A ° C.) of the coolant temperature may be set as 90° C.

Coasting of the vehicle may mean deceleration driving or downhill driving without using power.

The control unit 201 determines that a cetane number measuring mode of fuel is performed when the coolant temperature exceeds the predetermined reference temperature (A ° C.) and fuel-cut control is performed during the coasting of the vehicle.

The control unit 201 injects a fuel amount corresponding to pilot injection to each cylinder when the cetane number measuring mode of fuel is performed, and detects combustion pressure of each cylinder.

The control unit 201 calculates an HHR (heat release rate) by combustion from the combustion pressure of each cylinder by using the following Equation 1.

$$\begin{matrix}δ {Q}_{h r} = dU + δ W + δ {Q}_{w} \\ = \frac{γ}{γ - 1} pdV + \frac{1}{γ - 1} Vdp + δ {Q}_{w}\end{matrix} \qquad Eq . ( 1 )$$

In the above Equation 1, δQₕᵣ is the HHR, dU is a change of internal energy, δW(= [symbol] pdV) is work exerted on a piston, δQ [symbol] _{w} to is heat transfer to a cylinder wall, and γ(=cₚ/cᵥ) is a heat specific ratio.

The control unit 201 calculates start timing of combustion from the HHR when the HHR is calculated by the combustion pressure, and calculates an ignition delay time (t) from injection timing of fuel to the start timing of combustion.

The control unit 201 obtains an ignition delay difference (t−t2) comparing current ignition delay time (t) of fuel injected into the engine to an ignition delay time (t2) of standard fuel with a cetane number of 51.

Also, the control unit 201 calculates cetane number of fuel injected into the engine by using the following equation.

X=100−(100−X2)×(t−t1)/(t2−t1) Eq. (2)

In the above equation, X is the cetane number of injected fuel, X2 is the cetane number of standard fuel (cetane number of 51 based on Korean fuel), t is an ignition delay time of fuel injected into the engine, t1 is an ignition delay time of fuel having a cetane number of 100, and t2 is an ignition delay time of the standard fuel.

The control unit 201 corrects fuel injection timing to all cylinders to perform ignition timing the same as the standard fuel by using the ignition delay difference and the cetane number when the ignition delay difference and the cetane number are calculated.

For example, the fuel injection timing is corrected by advancing the injection timing or delaying the injection timing based on ignition timing of the standard fuel having a cetane number of 51.

That is, the injection timing is advanced when the cetane number of injected fuel is less than the cetane number of the standard fuel, and the injection timing is delayed when the cetane number of the injected fuel is higher than the cetane number of the standard fuel.

Therefore optimized combustion is performed irrespective of fuel quality, emissions are stabilized, and output of the engine and fuel consumption are improved.

The control unit 201 repeatedly corrects the injection timing through closed loop control according to the cetane number of the fuel, and stops correction control of the injection timing when the engine is turned off.

An opening of a nozzle provided in the injector 301 and opening timing are controlled by a control signal transmitted from the control unit 201, and thereby the injector 301 injects fuel to each corresponding cylinder with corrected injection timing.

Hereinafter, an injection control operation of the injection control apparatus controlling depending on fuel quality according to various embodiments of the present invention will be described in detail with reference to accompanied drawings.

When driving of a diesel vehicle with the injection control apparatus according to the present invention is started, the control unit 201 detects overall driving information including engine speed, coolant temperature, displacement of an accelerator pedal, vehicle speed, and pressure of combustion at step S101.

The control unit 201 analyzes the driving information detected at step S101, determines whether the coolant temperature exceeds a predetermined reference temperature (A ° C.) at which closed loop control is performed after sufficient warm up is completed, and determines whether fuel-cut control is performed according to coasting of the vehicle at step S102.

The reference temperature (A ° C.) of the coolant temperature may be set as 90° C.

The coasting may mean deceleration driving or downhill driving without using power.

The control unit 201 determines that a cetane number measuring mode of fuel is performed when the coolant temperature exceeds the predetermined reference temperature (A ° C.) and fuel-cut control is performed according to coasting at step S102.

The control unit 201 injects a fuel amount corresponding to pilot injection to each cylinder through the injector 301 when the cetane number measuring mode of fuel is performed at step S103, and detects combustion pressure of each cylinder from the combustion pressure detection unit 105 installed in each cylinder at step S104.

The control unit 201 calculates the HHR (heat release rate) from the combustion pressure of each cylinder detected from step S104 by using the following Equation 2 at step S105.

$$\begin{matrix}δ {Q}_{h r} = dU + δ W + δ {Q}_{w} \\ = \frac{γ}{γ - 1} pdV + \frac{1}{γ - 1} Vdp + δ {Q}_{w}\end{matrix} \qquad Eq . ( 3 )$$

In the above Equation 2, δQₕᵣ is the HHR by combustion, dU is a change of internal energy, δW(=pdV) is work exerted on a piston, δQ^{w} is heat transfer to a cylinder wall, and γ(=cₚ/cᵥ) is a heat specific ratio.

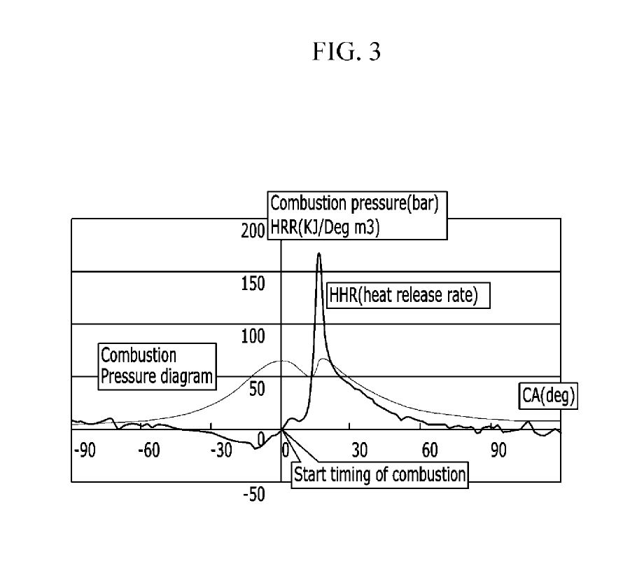

As shown is FIG. 3, the control unit 201 calculates start timing of combustion from the calculated HHR at step S105, and calculates an ignition delay time (t) from injection timing of the fuel to the start timing of combustion.

The control unit 201 obtains an ignition delay difference (t−t2) found by comparing the ignition delay time (t) calculated at step S105 to a standard ignition delay time (t2) of standard fuel with a cetane number of 51 at step S106.

The control unit 201 calculates the cetane number of fuel injected into the engine by using the following equation at step S107.

X=100−(100−X2)×(t−t1)/(t2−t1) Eq. (4)

In the above equation, X is the cetane number of injected fuel, X2 is a cetane number of the standard fuel (cetane number of 51 based on Korean fuel), t is an ignition delay time of the fuel injected into the engine, t1 is an ignition delay time of fuel having a cetane number of 100, and t2 is an ignition delay time of the standard fuel.

The control unit 201 obtains the ignition delay difference at steps S106 and S107. When the ignition delay difference and the cetane number are calculated, the control unit 201 corrects fuel injection timing to all cylinders to perform ignition timing the same as the standard fuel by using the ignition delay difference and the cetane number at step S108.

For example, the fuel injection time is corrected by advancing the injection timing or delaying the injection timing based on ignition timing of the standard fuel having the cetane number of 51.

That is, the injection timing is advanced when the cetane number of the injected fuel is less than the cetane number of the standard fuel, and the injection time is delayed when the cetane number of the injected fuel is higher than the cetane number of the standard fuel.

Therefore, optimized combustion is provided irrespective of fuel quality, emission is stabilized, and output of the engine and fuel consumption are improved.

The control unit 201 determines whether the engine is turned off at step S109. When the engine is not turned off, the control unit 201 returns to the step S101, and repeatedly corrects the injection timing according to the cetane number of the fuel.

The control unit 201 stops correction control of the injection time when the engine is turned off at step S109.

As described, the present invention determines quality of the fuel, corrects fuel injection timing, and provides optimized combustion. Therefore, emission is stabilized and fuel consumption is improved.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An ignition control apparatus depending on fuel quality of a diesel vehicle, comprising:
a driving information detection unit detecting driving information which is necessary to drive the vehicle;
a control unit determining a fuel injection amount and injection timing according to the driving information provided from the driving information detection unit; and
an injector injecting a fuel amount calculated by the control unit;
wherein the control unit detects a combustion pressure of each cylinder by injecting a pilot fuel amount when closed loop control is started after warm-up of an engine is completed, obtains a difference between ignition timings according to cetane numbers of fuels by calculating a heat release rate (HHR) from the combustion pressure, and controls the fuel injection timing based on the difference between the ignition timings.

2. The ignition control apparatus controlling depending on fuel quality of a diesel vehicle of claim 1, wherein the driving information detection unit comprises:
an engine speed detection unit detecting an engine speed from a phase change of a crankshaft or camshaft;
a coolant temperature detection unit detecting a temperature of a coolant circulating in the engine;
an accelerator pedal detection unit detecting a displacement of an accelerator pedal according to tip-in or tip-out of the accelerator pedal;
a vehicle speed detection unit detecting a vehicle speed from a rotation speed of an output shaft of a transmission; and
a combustion pressure detection unit detecting the combustion pressure of each cylinder through a combustion sensor installed to each cylinder of the engine.

3. The ignition control apparatus controlling depending on fuel quality of a diesel vehicle of claim 1, wherein the control unit determines that a cetane number measuring mode of fuel is performed when the coolant temperature exceeds a predetermined reference temperature and a fuel-cut control is performed during coasting of the vehicle.

4. The ignition control apparatus controlling depending on fuel quality of a diesel vehicle of claim 1, wherein the control unit calculates the HHR from the combustion pressure of each cylinder as follows:
$$\begin{matrix}δ {Q}_{h r} = dU + δ W + δ {Q}_{w} \\ = \frac{γ}{γ - 1} pdV + \frac{1}{γ - 1} Vdp + δ {Q}_{w}\end{matrix}$$
wherein δQₕᵣ is the HHR, dU is a change of internal energy, δW(=pdV) is work exerted on a piston, δQ_{w} is heat transfer to a cylinder wall, and γ(=cₚ/cᵥ) is a heat specific ratio.

5. The ignition control apparatus controlling depending on fuel quality of a diesel vehicle of claim 1, wherein the control unit calculates a start timing of combustion from the HHR calculated by the combustion pressure, calculates an ignition delay time (t) from the injection timing to the start timing of the combustion, and obtains an ignition delay difference (t−t2) by comparing the ignition delay time (t) to a standard ignition delay time (t2).

6. The ignition control apparatus controlling depending on fuel quality of a diesel vehicle of claim 1, wherein the control unit calculates the cetane number of the fuel as follows:
X=100−(100−X2)×(t−t1)/(t2−t1),
wherein X is a cetane number of injected fuel, X2 is a cetane number of standard fuel, t is an ignition delay time of the injected fuel to the engine, t1 is an ignition delay time of fuel having a cetane number of 100, and t2 is an ignition delay time of standard fuel.

7. The ignition control apparatus controlling depending on fuel quality of a diesel vehicle of claim 1, wherein the control unit advances the injection timing when the cetane number of the injected fuel is less than a cetane number of standard fuel, and delays the injection timing when the cetane number of the injected fuel is higher than a cetane number of standard fuel.

8. An ignition control method controlling depending on fuel quality of diesel vehicle, comprising:
detecting driving information including an engine speed, a coolant temperature, a displacement accelerator pedal, and a vehicle speed, and thereby determining whether a cetane number measure mode is satisfied;
detecting a combustion pressure of each cylinder by injecting a pilot fuel amount when the cetane number measuring mode is satisfied;
calculating an HHR (heat release rate) from the combustion pressure of each cylinder;
calculating start timing of combustion from the HHR, thereby calculating an ignition delay time from fuel injection timing to the start timing of combustion;
calculating a difference of the ignition delay time by comparing the ignition delay time of injected fuel to a standard ignition delay time; and
determining a cetane number of quality of fuel according to the difference of the ignition delay time.

9. The fuel quality dependent ignition control method of diesel vehicle of claim 8, wherein the cetane number measuring mode is determined when the temperature of a coolant exceeds a predetermined reference temperature (A ° C.) and fuel-cut control is performed during coasting of a vehicle.

10. The fuel quality dependent ignition control method of diesel vehicle of claim 8, wherein the HHR from the combustion pressure of each cylinder is calculated as follows:
$$\begin{matrix}δ {Q}_{h r} = dU + δ W + δ {Q}_{w} \\ = \frac{γ}{γ - 1} pdV + \frac{1}{γ - 1} Vdp + δ {Q}_{w} ,\end{matrix}$$
wherein δQₕᵣ is an HHR by combustion, dU is a change of internal energy, δW(=pdV) is work transferred to a piston, δQ_{w} is heat transfer to a cylinder wall, and γ(=cₚ/cᵥ) is a heat specific ratio.

11. The fuel quality dependent ignition control method of diesel vehicle of claim 8, wherein:
the injection time is advanced when the cetane number of the injected fuel is less than a cetane number of a standard fuel, and
the injection time is delayed when the cetane number of the injected fuel is higher than a cetane number of a standard fuel.

12. The fuel quality dependent ignition control method of diesel vehicle of claim 8, wherein:
the cetane number of the fuel is calculated as follows:
X=100−(100−X2)×(t−t1)/(t2−t1)
wherein X is a cetane number of injected fuel, X2 is a cetane number of standard fuel, t is an ignition delay time of the fuel injected into the engine, t1 is an ignition delay time of fuel having a cetane number of 100, and t2 is an ignition delay time of standard fuel.

13. An ignition control apparatus controlling depending on fuel quality of a diesel vehicle, including:
a driving information detection unit detecting driving information which is necessary to drive a vehicle;
a control unit controlling a fuel injection amount and injection timing according to the driving information provided from the driving information detection unit; and
a fuel injection unit injecting the fuel injection amount according to the control unit;
wherein the control unit determines quality of injected fuel by the method of claim 8 according to a predetermined program, and thereby controls fuel injection timing according to a determined quality of fuel.
